(19) United States
(12) Patent Application Publication
(10) Pub. No.: US 2025/0277392 A1
(43) Pub. Date: Sep. 4, 2025

(54) CONTROL DEVICE FOR A PUSH BAR LATCH

(71) Applicant: YI FAN LIAO, TAOYUAN CITY (TW)

(72) Inventor: YI FAN LIAO, TAOYUAN CITY (TW)

(21) Appl. No.: 19/211,734

(22) Filed: May 19, 2025

Related U.S. Application Data
(63) Continuation-in-part of application No. 18/355,113, filed on Jul. 19, 2023.

(30) Foreign Application Priority Data
Apr. 6, 2023 (TW) 112203124

(51) Int. Cl. E05B 47/02; E05B 65/10

(52) U.S. Cl. CPC E05B 47/023; E05B 65/1053

(57) ABSTRACT

A control device for a push bar latch, comprising: a base frame, the base frame has a pair of horizontal slide grooves and a pair of inclined slide grooves; a control connecting rod; a first positioning pin is arranged at the inner end thereof, the first positioning pin is set through the pair of horizontal slide grooves, and a second positioning pin is set through the pair of inclined slide grooves at the outer end thereof; a triangular blocking member; a locking lever, has a pivot hole pivot in the base frame by a shaft, the locking rod forms a lever structure with the pivot hole as the axis, make the electromagnet be energized to attract the locking rod with a very small suction force to achieve the effect of saving electricity.

This patent application is a continuation-in-part of Ser. No. 18/355,113, filed on Jul. 19, 2023.

### BACKGROUND OF THE INVENTION

### 1. Field of the Invention:

The invention relates to a control device for a push bar latch, especially one that has an enter control function.

### 2. Description of the Related Art

As shown in FIG. 2, the push bar latch 10 can be unlocked by pushing the push rod 11 to go out, and the setting range of the push rod 11 is very large, so that the push bar latch 10 is very convenient for unlocking and is often used in exit doors. However, there are more and more demands for access control, as long as there are no security concerns, adding a control device to the push bar latch 10 can facilitate the entry and exit of people and has an enter control function.

Referring to FIG. 1, U.S. Pat. No. 5,823,582, for an exit bar for securing a door, discloses a main housing 12′, a main lock frame 16, a master main link 32′, a slave main link 34, a drive link 62, and a min spring carrier 110. The master main link 32′ and slave main link 34 are pivotally connected to a push pad 30′ by pins 36 and 38. The drive link 62 is connected to the master main link 32′ by link pin 48. The device also includes an armature 70 and a master auxiliary link 78. The master auxiliary link 78 is pivotally connected to the drive link 62 by pin 80 and is also connected to an auxiliary armature tray 74 by pin 82. The device also has a retraction pad 56 and an electromagnet 64. The electromagnet 64 is used for holding the armature 70 to maintain the blocking member 56 in a locking state by maintaining the blocking member 56 away from the latch retraction lever, and the door is locked.

However, referring to the structure of U.S. Pat. No. 5,823,582, an electromagnet 64 is arranged at the middle, the armature 70 is arranged above the electromagnet 64, and the overall mechanical transmission method for unlocking is too complicated, which increases the power consumption of the electromagnet 64. For example, in order to prevent the door from being pushed open by others, the door lock must have a suction force of at least 500 pounds. However, the electromagnet 64 with a suction force of 500 pounds is very large and takes up a lot of space, which is not conducive to installation, and it consumes a lot of power. Additionally, all of the pins discussed are free floating without being guided by stabilizing slots. Therefore, it requires improvement.

### SUMMARY OF THE INVENTION

It is a primary objective of the present invention to provide a control device for a push bar latch, especially one that has the advantages of simple structure, high control stability, power saving and enter control function.

In order to achieve the above objectives, an embodiment of the present invention comprises:
a base frame 20, a control connecting rod 30, a locking lever 40, and an electromagnet 50, wherein
the base frame 20 has a pair of horizontal slide grooves 21 on both sides of the middle, and a pair of inclined slide grooves 22 are provided in front of the horizontal slide grooves 21;
the control connecting rod 30 is arranged on the base frame 20, a first positioning pin 31 is arranged at the inner end thereof, the first positioning pin 31 is set through the pair of horizontal slide grooves 21, and a second positioning pin 32 is set through the pair of inclined slide grooves 22 at the outer end thereof; furthermore, a torsion spring 13 is arranged at the bottom of the second positioning pin 32, so that the control connecting rod 30 can be displaced in the pair of inclined slide grooves 22 and the pair of horizontal slide grooves 21;
the locking lever 40, has a pivot hole 42 in the middle thereof and is pivot in the base frame 20 by a shaft 45, the locking lever 40 has a triangular blocking member 41 at the bottom of the outer end of the pivot hole 42 opposite to the first positioning pin 31, and a push spring 60 is arranged above the triangular blocking member 41, a longer inner end section 43 is formed at the other end of the triangular blocking member 41, which is served as a magnetic attraction surface 431, so that the locking lever 40 takes the pivot hole 42 as the axis to form a lever structure; and the electromagnet 50 is arranged on the base frame 20 relative to the magnetic attraction surface 431 of the inner end section 43 of the locking lever 40, and is used for holding the magnetic attraction surface 431 of the inner end section 43 of the locking lever 40, so let the triangular blocking member 41 enter a locking state for the first positioning pin 31; whereby, when the electromagnet 50 is energized to magnetize the magnetic attraction surface 431 on the inner end section of the locking lever 40, letting a front end surface 411 of the triangular blocking member 41 able to block the first positioning pin 31 downward, and enters a locked state (lock), so that the control connecting rod 30 enters a locked state, and the horizontal push bar latch 10 enters a close mode, at this time, even horizontally pushing the push rod 11 cannot unlock the door; Furthermore, when the electromagnet 50 is powered off, it no longer attracts the inner end section 43 of the locking lever 40, that is, the front end surface 411 of the triangular blocking member 41 releases the blocking state of the first positioning pin 31 and unlocks the door, at this time, the control connecting rod 30 is enable to displace in the pair of inclined slide grooves 22 and the pair of horizontal slide grooves 21, and the push bar latch 10 enters the open mode (unlock) that returns to the normal use state of the push bar latch 10, when someone horizontally pushes the push rod 11 at this time, the first positioning pin 31 can pass through the triangular blocking member 41 to unlock the door.

Also, the push spring is arranged on the base frame by a screw, and a concave hole is arranged on the top surface of the locking lever relative to the push spring.

Also, the first positioning pin 31 is sleeved with a sliding tube.

Also, the torsion spring 13 is set on the base frame 20 by a third positioning pin.

The effects of the present invention include: by the structural design and spatial arrangement of the control connecting rod 30, the locking rod 40, and the electromagnet 50, the locking rod 40 forms a lever structure with the pivot hole 42 as the axis, make the electromagnet 50 be energized to attract the locking rod 40 with a very small suction force to achieve the effect of saving electricity. Therefore, the overall structure is very different from that of U.S. U.S. Pat. No. 5,823,582. The present invention cleverly uses the lever principle of mechanics to make the locking rod 40 and the control connecting rod 30 transmit smoothly, and has a simple structure, high control stability and improved power saving.

### BRIEF DESCRIPTION OF THE DRAWINGS

FIG. 1 is a schematic diagram illustrating the structure of the prior art;

FIG. 2 is a schematic diagram illustrating the structure of the push bar latch installed with a preferred embodiment of the present invention;

FIG. 3 is an exploded perspective view of the push bar latch of a preferred embodiment of the present invention;

FIG. 4 is an exploded perspective view of a preferred embodiment of the present invention;

FIG. 5 is an assembly perspective view of the main structure of a preferred embodiment of the present invention;

FIG. 6A is a sectional view of a preferred embodiment of the present invention in closed mode;

FIG. 6B is an enlarged view of 6B in FIG. 6A;

FIG. 7A is a sectional view of a preferred embodiment of the present invention in open mode;

FIG. 7B is an enlarged view of 7B in FIG. 7A;

FIG. 8A is a sectional view of a preferred embodiment of the present invention in unlocking mode; and

FIG. 8B is an enlarged view of 8B in FIG. 8A.

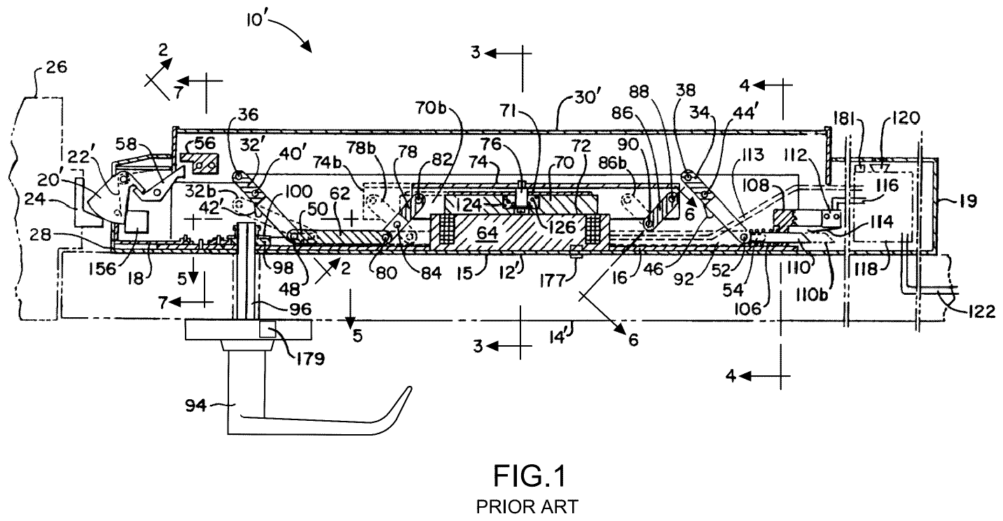

### DETAILED DESCRIPTION OF THE PREFERRED EMBODIMENT

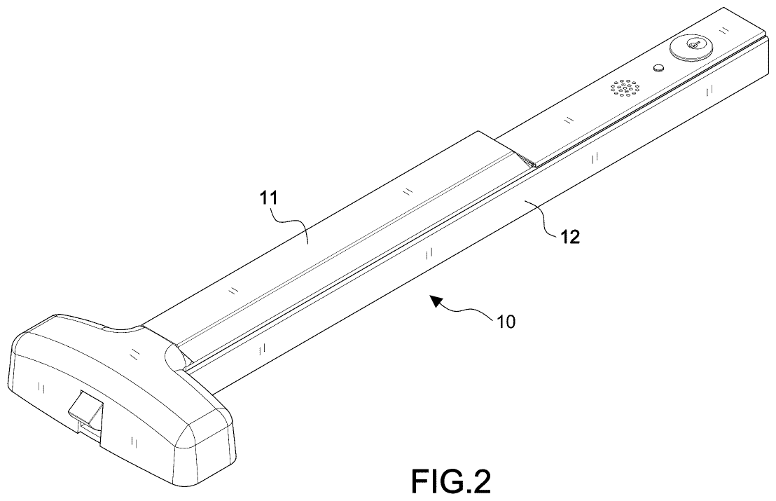

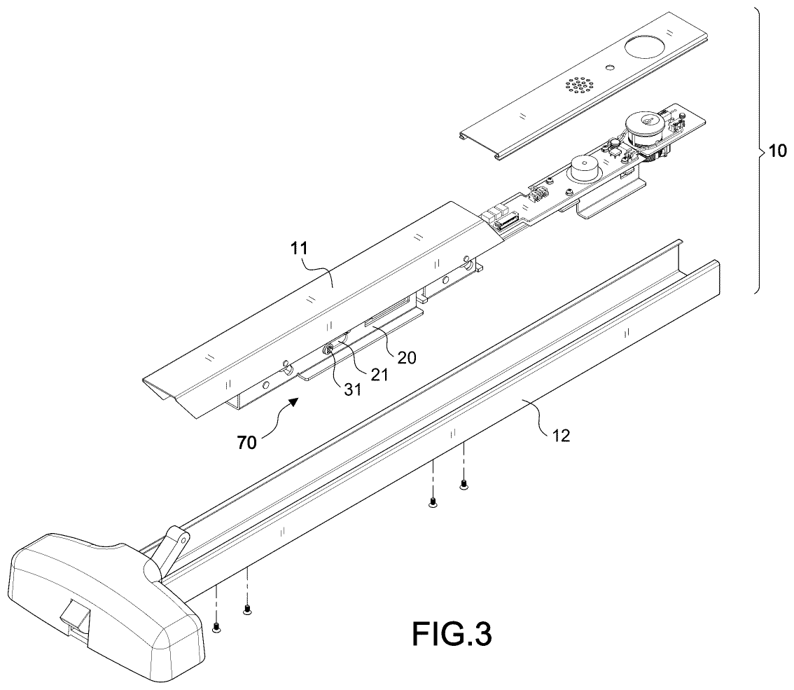

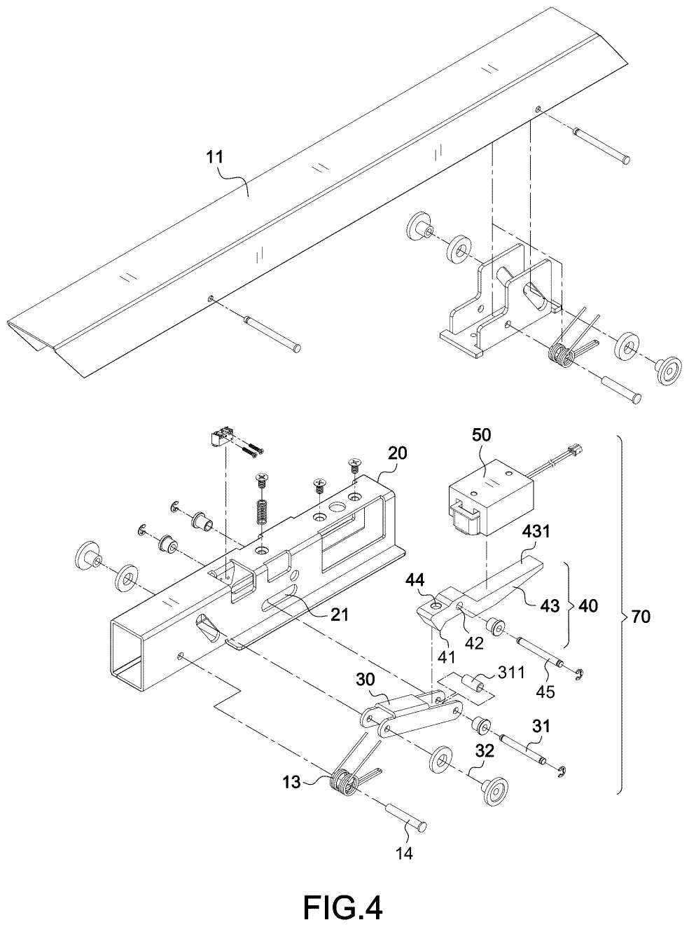

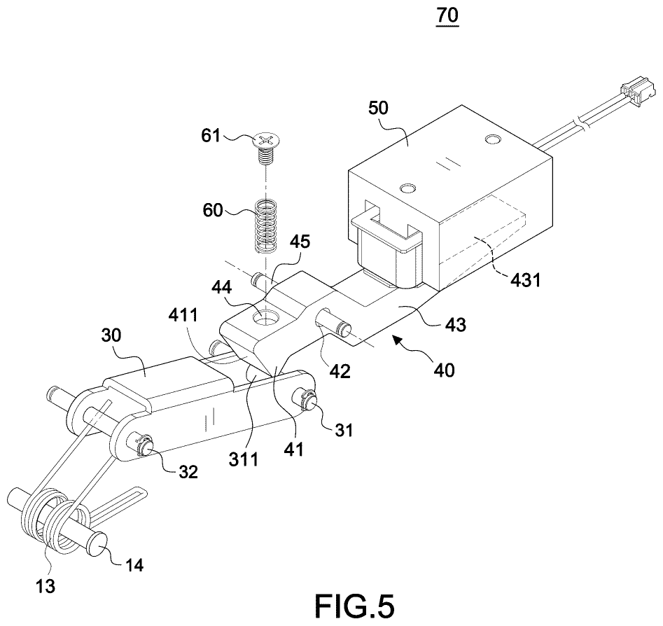

Referring to FIGS. 2-8, a push bar latch 10 includes a main body 12 and a push rod 11 arranged on the main body 12, and a control device 70 is arranged between the push rod 11 and the main body 12. The control device 70 includes: a base frame 20, a control connecting rod 30, a locking lever 40, and an electromagnet 50. Certain aspects of the above structure belong to the Prior Art of the horizontal push door lock, and so will not be described in detail here.

The illustrated embodiment of the present invention includes a base frame 20, the base frame 20 having a pair of horizontal slide grooves 21 on both sides of the middle. A pair of inclined slide grooves 22 are provided in front of the horizontal slide grooves 21. The illustrated embodiment of the present invention also includes a control connecting rod 30, the control connecting rod 30 being arranged on the base frame 20. A first positioning pin 31 is arranged at the inner end thereof, the first positioning pin 31 is set through the pair of horizontal slide grooves 21, and a second positioning pin 32 is set through the pair of inclined slide grooves 22 at the outer end thereof. Furthermore, a torsion spring 13 is arranged at the bottom of the second positioning pin 32, so that the control connecting rod 30 can be displaced in the pair of inclined slide grooves 22 and the pair of horizontal slide grooves 21. That is, when the push rod 11 is pushed down to unlock, the second positioning pin 32 will move to the lower right in the figure, and the second positioning pin 32 will return to the locked position due to the upward elastic force of the torsion spring 13. In this embodiment, a sliding tube 311 is sleeved on the first positioning pin 31 to enable the first positioning pin 31 to slide smoothly. In addition, the torsion spring 13 can be mounted on the base frame 20 via a third positioning pin 14.

A locking lever 40 has a pivot hole 42 in the middle thereof and is pivoted in the base frame 20 by a shaft 45, the locking lever 40 has a triangular blocking member 41 at the bottom of the outer end of the pivot hole 42 opposite to the first positioning pin 31, and a push spring 60 is arranged above the triangular blocking member 41. A longer inner end section 43 is formed at the other end of the triangular blocking member 41, which serves as a magnetic attraction surface 431, so that the locking lever 40 takes the pivot hole 42 as the axis to form a lever structure.

The electromagnet 50 is arranged on the base frame 20 relative to the magnetic attraction surface 431 of the inner end section 43 of the locking lever 40, and is used for holding the magnetic attraction surface 431 of the inner end section 43 of the locking lever 40, enabling the triangular blocking member 41 to enter a locking state for the first positioning pin 31.

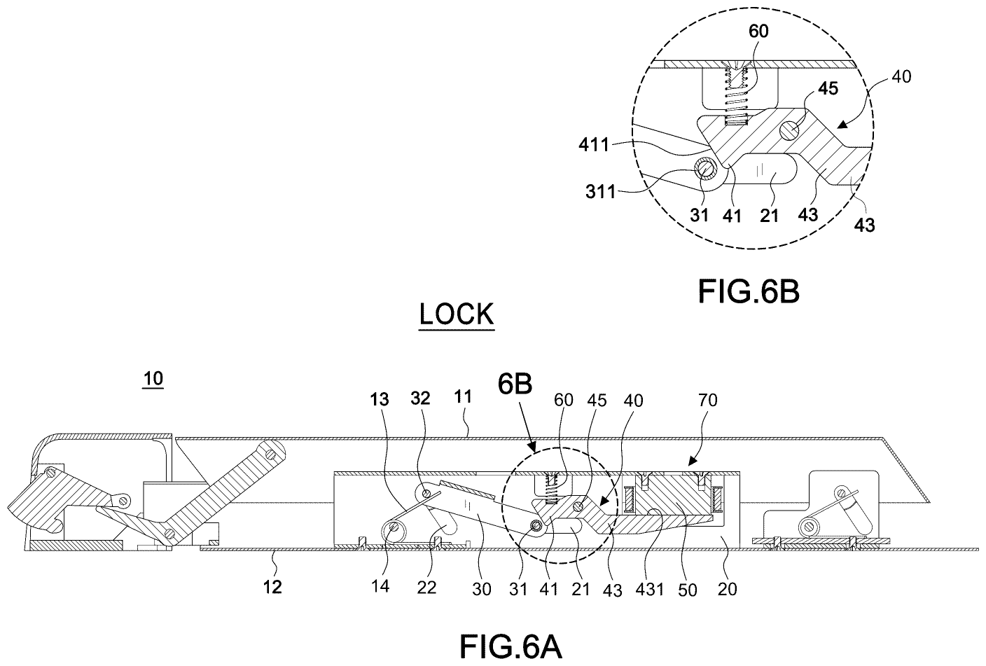

With the features disclosed above, as FIGS. 6A and 6B show, when the electromagnet 50 is energized to magnetize the magnetic attraction surface 431 on the inner end section of the locking lever 40, it enables a front end surface 411 of the triangular blocking member 41 to block the first positioning pin 31 downward and enter a locked state (lock), so that the control connecting rod 30 enters a locked state, and the horizontal push bar latch 10 enters a close mode. At this time, even horizontally pushing the push rod 11 cannot unlock the door.

The push spring 60 of the present invention allows the magnetic attraction surface 431 of the inner end section of the locking lever 40 to remain in contact with the electromagnet 50, ensuring that the electromagnet 50 can generate an adsorption force on the inner end section of the locking lever 40 when energized. In this embodiment, the push spring 60 is arranged on the base frame 20 by a screw 61, and a concave hole 44 is arranged on the top surface of the locking lever 40 relative to the push spring 60, so that the bottom of the push spring 60 is inserted into position.

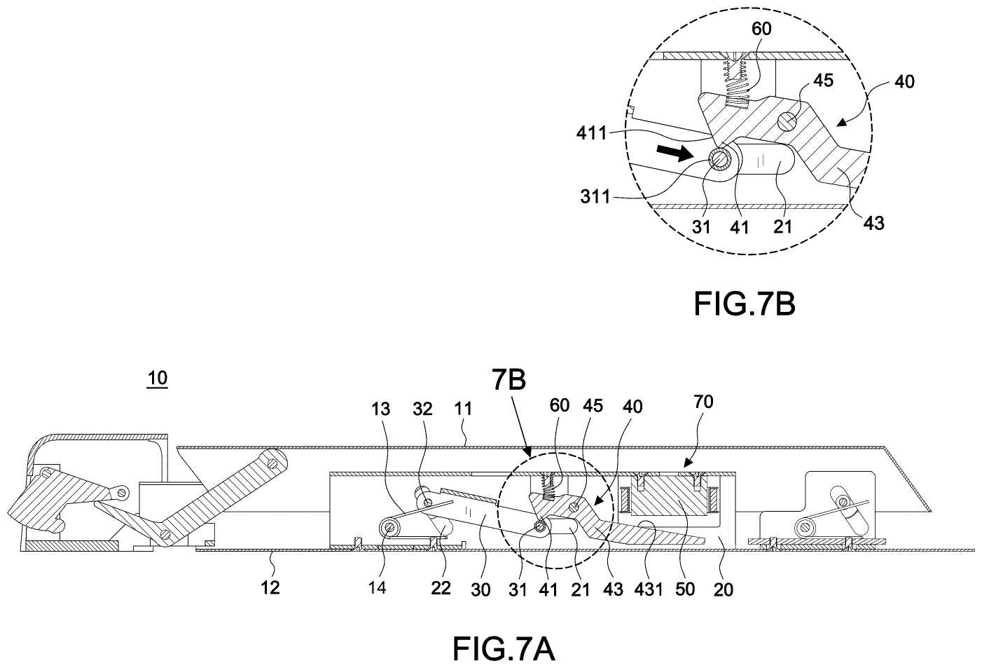

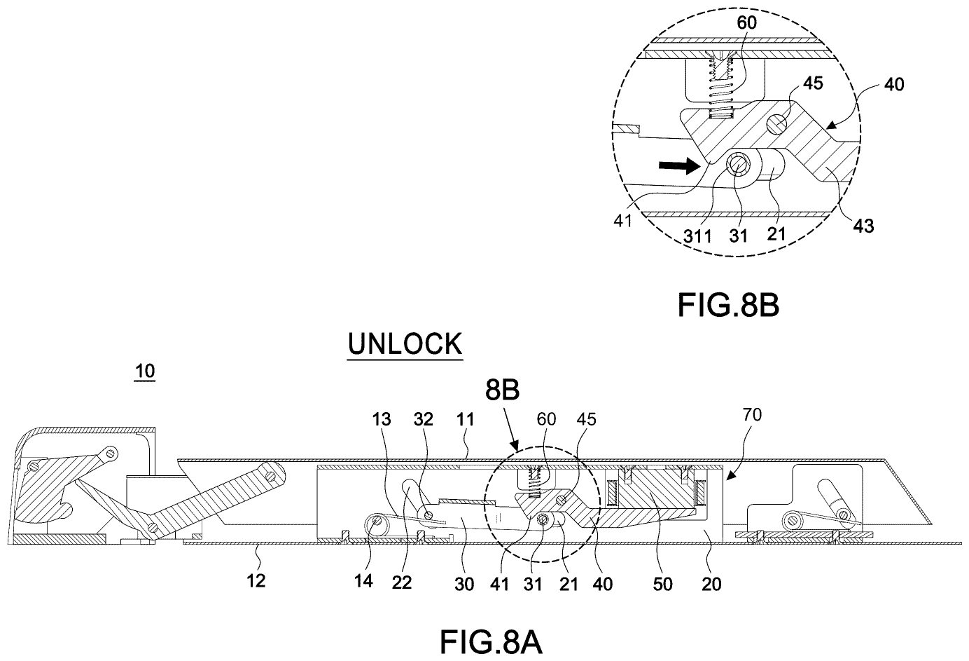

Furthermore, referring to FIGS. 7A and 7B, when the electromagnet 50 is powered off, it no longer attracts the inner end section 43 of the locking lever 40. That is, the front end surface 411 of the triangular blocking member 41 releases the blocking state of the first positioning pin 31 and unlocks the door; at this time, the control connecting rod 30 is enabled to displace in the pair of inclined slide grooves 22 and the pair of horizontal slide grooves 21. Then, the first positioning pin 31 passes the triangular blocking member 41, referring to FIGS. 8A and 8B, the push bar latch 10 enters the open mode (unlock) that returns to the normal use state of the push bar latch 10. When someone horizontally pushes the push rod 11 at this time, the first positioning pin 31 can pass through the triangular blocking member 41 to unlock the door.

Also, the base frame 20 can be a base frame owned by the push bar latch, and the design of the push bar latch can vary. During the unlocking process, in addition to the above-mentioned situation that the second positioning pin 32 can shift to the lower right in the figure, other designs can also be shifted to the lower left in the figure, or even simply shifted to the left or right, and the mechanism of the present invention can be applied to all of them. If the push bar latch is the kind that will make the second positioning pin 32 shift to the right in the figure, the initial position of the first positioning pin 31 will be located on the left side of the triangular blocking member 41, and the electromagnet 50 can hold the triangular blocking member 41 through magnetic force to prevent the first positioning pin 31 from shifting to the right, so that the first positioning pin 31 enters the locked state. If the push bar latch is the kind that will make the second positioning pin 32 shift to the left in the figure, the initial position of the first positioning pin 31 will be located on the right side of the triangular blocking member 41, and the electromagnet 50 can hold the triangular blocking member 41 through magnetic force to prevent the positioning pin 31 from shifting to the left, so that the positioning pin 31 enters the locked state.

Therefore, by the structural design and spatial arrangement of the control connecting rod 30, the locking rod 40, and the electromagnet 50, the locking rod 40 forms a lever structure with the pivot hole 42 as the axis, enabling the electromagnet 50 to be energized to attract the locking rod 40 with a very small suction force to achieve the effect of saving electricity. For example, in order to prevent the door from being pushed open by others, the door lock must have a suction force of at least 500 pounds. However, the electromagnet with a suction force of 500 pounds is very large and takes up a lot of space, which is not conducive to installation, and it consumes a lot of power. Therefore, it requires improvement. In contrast, the present invention utilizes a longer inner end section 43 that can serve as a magnetic attraction surface 431, and the electromagnet 50 only needs 100 pounds of suction force to attract the locking lever 40, so the electromagnet 50 is small in size, easy to install, and very energy-saving. Therefore, the overall structure of the present invention is very different from that of U.S. Pat. No. 5,823,582. The present invention cleverly uses the lever principle of mechanics to make the locking rod 40 and the control connecting rod 30 transmit smoothly, and has a simple structure, high control stability, and improved power saving.

What is claimed is:

1. A control device for a push bar latch, comprising:
a base frame (20), a control connecting rod (30), a locking lever (40), and an electromagnet (50), wherein
the base frame (20) has a pair of horizontal slide grooves (21) on both sides of a middle section of the base frame (20), and a pair of inclined slide grooves (22) are provided on both sides of the base frame (20) displaced from the horizontal slide grooves (21);
the control connecting rod (30) is arranged on the base frame (20), a first positioning pin (31) is arranged at a first end of the control connecting rod (30), the first positioning pin (31) is set through the pair of horizontal slide grooves (21), and a second positioning pin (32) is set through the pair of inclined slide grooves (22) at a second end of the control connecting rod (30);
furthermore, a torsion spring (13) is arranged at the bottom of the second positioning pin (32), so that the control connecting rod 30 can be displaced in the pair of inclined slide grooves (22) and the pair of horizontal slide grooves (21);
the locking lever (40), has a pivot hole (42) in a middle section thereof and is pivoted in the base frame (20) about a shaft (45), the locking lever 40 has a triangular blocking member (41) at the bottom of a first end of the locking lever (40) opposite to the first positioning pin (31), and a push spring (60) is arranged above the triangular blocking member (41), a longer second end section (43) of the locking lever (40) is formed at the opposite end of the locking lever (40) having the triangular blocking member (41), which is served as a magnetic attraction surface (431), so that the locking lever 40 takes the pivot hole (42) as the axis to form a lever structure; and
the electromagnet (50) is arranged on the base frame (20) relative to the magnetic attraction surface (431) of the second end section (43) of the locking lever (40), and is used for holding the magnetic attraction surface (431) of the second end section (43) of the locking lever (40), so let the triangular blocking member (41) enter a locking state for the first positioning pin (31);
whereby, when the electromagnet (50) is energized to magnetize the magnetic attraction surface (431) on the second end section of the locking lever (40), a front end surface (411) of the triangular blocking member (41) blocks movement of the first positioning pin (31), and enters a locked state, so that the control connecting rod (30) enters a locked state, and the horizontal push bar latch (10) enters a close mode,
when the electromagnet (50) is de-energized, the second end section (43) of the locking lever 40 is released, wherein the front end surface (411) of the triangular blocking member (41) releases the blocking state of the first positioning pin (31), the control connecting rod (30) is enabled for displacement in the pair of inclined slide grooves (22) and the pair of horizontal slide grooves (21), and the push bar latch (10) enters an open mode that returns to the normal use state of the push bar latch (10), when the push rod (11) is horizontally pushed, the first positioning pin (31) deflects the triangular blocking member (41).

2. The control device for a push bar latch as claimed in claim 1, wherein the push spring is arranged on the base frame by a screw, and a concave hole is arranged on the top surface of the locking lever relative to the push spring.

3. The control device for a push bar latch as claimed in claim 1, wherein the first positioning pin (31) is sleeved with a sliding tube.

4. The control device for a push bar latch as claimed in claim 1, wherein the torsion spring (13) is set on the base frame (20) by a third positioning pin.
